(19) United States
(12) Patent Application Publication
(10) Pub. No.: US 2012/0200000 A1
(43) Pub. Date: Aug. 9, 2012

(54) Device and Method for Treating a Bulk Material

(75) Inventors: Frieder Klein, Tagerwilen (CH); Kasim Palaz, Gossau (CH)

(73) Assignee: BUHLER AG, Uzwil (CH)

(21) Appl. No.: 13/500,541

(22) PCT Filed: Oct. 21, 2010
(86) PCT No.: PCT/EP10/65846

§ 371 Date: Apr. 5, 2012

(30) Foreign Application Priority Data
Oct. 29, 2009 (EP) 09174499.5-1253

(51) Int. Cl. B01F 7/00; B29B 7/30; B29C 47/00; B01F 15/06

(52) U.S. Cl. 264/176.1; 366/279; 366/145; 425/200

(57) ABSTRACT

The invention relates to a device comprising a substantially cylindrical housing (2) in a mixing region (7). Said housing comprises at least one outlet channel (15) having an outlet opening (6) in the mixing region (7) and at least one rotationally supported mixing shaft (4) having at least one discharge element (3) having an effective surface. The discharge element (3) can be guided past the outlet opening (6) when used properly, wherein a projection of the effective surface (8) parallel to the outlet channel axis covers the smallest outlet channel cross section of the outlet opening (6) at least once per revolution of the discharge element (3) by at least 45%, preferably by at least 50%, particularly preferably by at least 55%, and most particularly preferably by at least 60%. The projection of the effective surface (8) parallel to the outlet channel axis preferably covers the smallest outlet channel cross section of the outlet opening (6) at least once per revolution of same by at least 50%, particularly preferably by at least 55%, and most particularly preferably by at least 60%.

The present invention relates to the field of treating, in particular mixing, a bulk material with the features of the preambles of the independent claims.

EP 0 303 929 discloses a comminuting and mixing device for processing thermoplastic synthetic material, the processed synthetic material being transported into a screw extruder. This previously known device has a receiving container with a comminuting and mixing tool rotating about the container axis. This tool is attached near the bottom of the container. The receiving container has an opening in its shell, through which a screw extruder is in flow communication with the receiving container. The opening opens out approximately tangentially into the shell of the receiving container. A screw of the screw extruder is made to extend at least almost up to the inner wall of the receiving container. The comminuting and mixing tool is at a distance axially from the opening.

This previously known device for comminuting and mixing a synthetic material has the disadvantage, however, that the mass throughput from the receiving container into the extruder often does not satisfy today's requirements, insofar as just mixing with a high throughput is desired. Furthermore, the structural design for making the screw of the screw extruder extend almost up to the inner wall of the receiving container is complex. This solution is consequently very costly.

It is therefore an object of the present invention to avoid the disadvantages of the known art, that is in particular to provide a device and a method with which a bulk material can be treated, in particular can be mixed, at low cost and with high material throughput.

For the purposes of the application, material throughput is understood as meaning sufficient treatment, in particular mixing, of material, specified for example in kilograms per hour or tonnes per hour.

For the purposes of the application, treatment of a bulk material is understood as meaning, for example, mixing, exposure to vapor, in particular steam, or else a thermal treatment of the bulk material. These treatments may be carried out individually or else in any desired combination.

These objects are achieved by a device and method according to the characterizing part of the independent claims.

The device according to the invention has a housing which is substantially cylindrical in a mixing region. This housing comprises at least one outlet channel with an outlet opening in the mixing region and at least one rotatably mounted mixer shaft with at least one discharge element with an effective surface. When used in the way intended, the discharge element can be made to pass the outlet opening, wherein a projection of the effective surface parallel to the outlet channel axis onto the outlet opening covers the smallest outlet channel cross section by at least 45% at least once per revolution of the discharge element. The projection of the effective surface parallel to the outlet channel axis onto the outlet opening preferably covers the smallest outlet channel cross section by at least 50%, particularly preferably by at least 55% and most particularly preferably by at least 60%, once per revolution.

For the purposes of the application, the outlet channel axis is understood as meaning a longitudinal axis of a symmetrical channel, for example with a circular, elliptical or rectangular cross section, perpendicular to the cross-sectional area. In the case of non-symmetrical channels, the outlet channel axis is understood as meaning such a longitudinal axis that lies substantially parallel to the average direction of flow of a bulk material flowing in the channel.

For the purposes of the application, the smallest outlet channel cross section is understood as meaning the smallest cross section of the outlet channel along the outlet channel axis.

In particular, the outlet channel is formed with a continuous progression of the inner wall. In other words, an inner wall of the outlet channel has no irregularities, such as for example projecting or set-back stages or, in particular, also has no covering of the inlet opening. Such a continuous progression of the outlet channel has the advantage of substantially avoiding the creation of zones in the outlet channel in which bulk material is not reliably transported, and consequently bulk material can become deposited in the outlet channel. This has the further advantage that the screw conveyors or extruder screws that are sometimes necessary according to the prior art in the outlet channel for transporting the bulk material along the outlet channel can be omitted, which makes the device less costly.

Examples of bulk material that can be treated, for the purposes of the application also including pourable products, are cereal flour, whole cereal grains, cereal fibers, vegetable or animal proteins, pure starch flour and bran. However, it is also possible, for example, to treat plastics granules or pellets in the device.

For the purposes of the application, an effective surface of a discharge element is understood as meaning the surface of the discharge element that produces the main component, i.e. at least 90%, of the transfer of momentum to the bulk material by the discharge element when the discharge element moves in the way intended in the device. The effective surface does not include, for example, a mount of the discharge element.

For the purposes of the application, can be made to pass means that the discharge element is attached to the mixer shaft level with the outlet opening, and consequently, during use of the discharge element as intended, for example during rotation thereof, is made to pass the outlet opening as it rotates.

For the purposes of the application, a mixing region is understood as meaning the region of the device in which the mixer shaft has discharge elements and/or mixing elements. In this region, the housing is substantially cylindrical. In other words, outside this region the device may, for example, also have a rectangular cross section or else bends for guiding the bulk material into the mixing region.

The advantage of the device according to the invention is that a bulk material located in the device can be transported out of the device through the outlet opening with high throughput. The transfer of momentum to the bulk material takes place, in particular also partially parallel to the outlet channel axis, as a result of the movement of the discharge element, which also leads to an increased throughput of bulk material through the outlet opening on account of the centrifugal force acting on the bulk material, i.e. the bulk material is ejected.

In terms of the structural design, this is achieved by the outlet channel being attached to the substantially cylindrical housing substantially tangentially in the mixing region. Substantially tangentially has the meaning here that the outlet channel axis has no point of intersection with the axis of the mixer shaft.

The mixer shaft preferably has two discharge elements. In particular, the mixer shaft has three discharge elements, particularly preferably four discharge elements and most particularly preferably at least five discharge elements.

This configuration with at least two discharge elements has the advantage that the transport through the outlet opening is improved, that is to say that, inter alia, the material throughput through the device is increased.

More preferably, the mixer shaft is mounted on both sides.

This has the advantage that the stability of the mixer shaft is increased by being mounted on both sides, allowing it either to rotate faster or to have more discharge elements and/or mixing elements for improved, that is to say in particular faster, treatment of the bulk material. This achieves an increase in the throughput through the device.

More particularly preferably, a perpendicular to the effective surface of at least one discharge element forms an angle of substantially 90° with the axis of the mixer shaft. A perpendicular to an effective surface is understood here and hereafter as meaning the perpendicular line on the effective surface.

This orientation of the effective surface in relation to the mixer shaft has the advantage that the transport of the bulk material through the outlet opening is further improved.

The effective surface of at least one discharge element is preferably at a distance perpendicularly to the radius of the cylindrical housing in the direction of rotation or counter to the direction of rotation of the discharge element.

This has the advantage that the transport of the bulk material through the outlet channel is further improved.

Particularly preferably, the perpendicular to the effective surface of at least one mixing element forms an angle of less than 90° with the axis of the mixer shaft. The perpendicular to the surface preferably forms an angle of 45° to 85° with the axis of the mixer shaft.

This arrangement of the effective surface of a mixing element in relation to the axis of the mixer shaft has the advantage that the bulk material is transported along the axis of the mixer shaft. By this arrangement, the bulk material is therefore treated, in particular mixed, and simultaneously transported along the axis of the mixer shaft.

The mixer shaft preferably has at least two discharge elements and mixing elements at a distance parallel to the axis of the mixer shaft. In other words, the mixer shaft has at least one discharge element and at least one mixing element which are at a distance parallel to the axis of the mixer shaft.

The advantage of the arrangement of at least two discharge elements and mixing elements that are at a distance parallel to the axis of the mixer shaft has the advantage that they respectively have different orientations of the perpendicular to the surface in relation to the axis of the mixer shaft. The individual mixing elements and discharge elements can therefore be optimized for mixing the bulk material and transporting it along the axis of the mixer shaft or else for improving the transport of the bulk material through the outlet opening.

In particular, the mixer shaft has at least one mixing element upstream of the outlet opening.

Furthermore, the mixing elements upstream of the outlet opening restrict the possibility of bulk material being transported upstream from the outlet opening, i.e. they represent a flow resistance for the bulk material in the device upstream of the outlet opening.

This arrangement of at least one mixing element upstream of the outlet opening has the advantage that bulk material is reliably conveyed through the outlet opening by means of the at least one discharge element. Consequently, in particular, no bulk material collects in the device, which is disadvantageous. In particular, bulk material does not remain in the device any longer than a period of time specified as advantageous for it, which increases the quality of the mixed bulk material.

Most particularly preferably, at least one discharge element has an effective surface which, parallel to the mixer shaft, is greater than the outlet opening.

This has the advantage that the transport of the bulk material through the outlet opening is further improved.

In a further particularly preferred embodiment, an extruder is arranged alongside the outlet opening and is connected to it in such a way that a bulk material can be made to pass from the device to the extruder.

This arrangement of the device alongside the extruder has the advantage that the bulk material is treated, particular mixed, in the device before it enters the extruder. The device according to the invention is therefore also referred to as a preconditioner. This treatment of the bulk material in the device before it enters the extruder makes it possible to prepare the bulk material for the extrusion.

Also most particularly preferably, the longitudinal axis of the extruder forms an angle of 60° to 120° with the axis of the mixer shaft. In particular, this angle lies in a range from 70° to 110°, particularly preferably from 80° to 100° and most particularly preferably is substantially 90°.

This arrangement of the device and the extruder has the advantage that such an arrangement allows a very small distance between the device and the downstream extruder. This arrangement achieves the effect in particular that the extruder only has to have one opening in the region of the outlet opening, and consequently it is only here that the housing of the extruder is weakened in its stability. In the prior art, by contrast, it is necessary to modify the housing of the extruder parallel to the longitudinal axis of the extruder, and thereby weaken it, in order to achieve the small distance between the device and the extruder, since in the prior art a parallel arrangement is used.

Also most particularly preferably, a flank of an extruder shaft has a minimum distance perpendicularly to the extruder shaft of no more than 20 mm from the radially outermost point of the discharge element at least once per revolution. This minimum distance is preferably no more than 10 mm, most particularly preferably this minimum distance is no more than at least 5 mm and more particularly preferably at least 1 mm.

For the purposes of the application, the flank of an extruder shaft is the outer radius in the region of the device.

This small distance has the advantage that only a small volume of bulk material can collect in the region between the outlet opening of the device and the extruder inlet opening. This volume represents what is known as a product bridge, which is intended to be as small as possible in order to avoid instances of clumping and/or clogging, which in the prior art however is scarcely achievable.

Most particularly preferably, the device is configured in such a way that the interior of the housing can be exposed to vapor. The interior of the housing can be exposed in particular to steam.

This has the advantage that, in addition to mixing and transporting, the bulk material in the device is pretreated in an optimized manner with a view to the subsequent extrusion.

Alternatively or in addition, it is also possible, for example, to expose the interior of the housing to oil or other liquids or else vapors of these liquids.

In a further particularly preferred embodiment, the device has a temperature control unit. The device has in particular a heating unit.

This has the advantage that the bulk material can be set by the temperature control unit to an optimum temperature for treating the bulk material in the device with a view to the subsequent extrusion step.

A further aspect of the invention is directed at a method for mixing a bulk material with a device, in particular as described above. In a first step, bulk material is introduced into the device. The device has in this case a housing which is substantially cylindrical in a mixing region and comprises at least one outlet channel with an outlet opening in the mixing region. Furthermore, the device has at least one rotatably mounted mixer shaft with at least one discharge element with an effective surface. When used in the way intended, the discharge element is made to pass the outlet opening, wherein a projection of the effective surface parallel to the outlet channel axis onto the outlet opening covers the smallest outlet channel cross section by at least 45% at least once per revolution of the discharge element. The projection of the effective surface parallel to the outlet channel axis onto the outlet opening preferably covers the smallest outlet channel cross section by at least 50%, particularly preferably by at least 55% and most particularly preferably by at least 60%, once per revolution. This is followed by the mixing of the bulk material in the device and the transporting of the mixed bulk material to an outlet opening. Subsequently, the mixed bulk material is discharged from the device by means of the discharge element.

This method is preferably carried out with the device described above, and consequently has all of the advantages of the device that are described above.

The mixed bulk material discharged from the device is preferably transported into an extruder.

A further aspect of the invention is directed at the upgrading or conversion of an existing installation for processing raw materials, in particular bulk material, preferably an extrusion installation, with the device described above.

This method has the advantage that installations that are already in operation can be brought up to the latest state of the art. Therefore, installations that previously did not have a device according to the invention can be upgraded with a corresponding device. Furthermore, installations that already have a device according to the prior art can be converted to have the device according to the invention.

An additional aspect of the invention is directed at the use of the device described above as a conditioner for extrusion installations.

This use as a conditioner for extrusion installations has the advantage that the bulk material to be treated in the extrusion installation can be pretreated in the conditioner, so that the bulk material is prepared for an optimum extrusion result.

The invention is explained in more detail below on the basis of exemplary embodiments for better understanding, without restricting the invention to the exemplary embodiments.

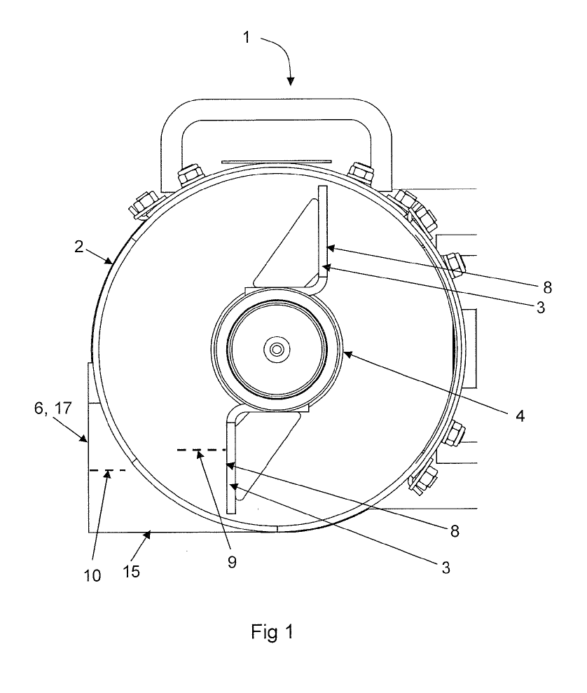

FIG. 1 a section through the device according to the invention;

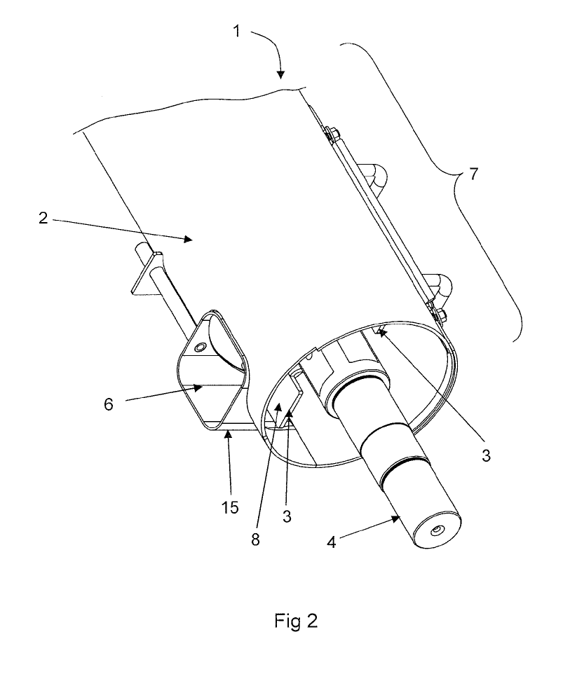

FIG. 2 a perspective representation of a device according to the invention;

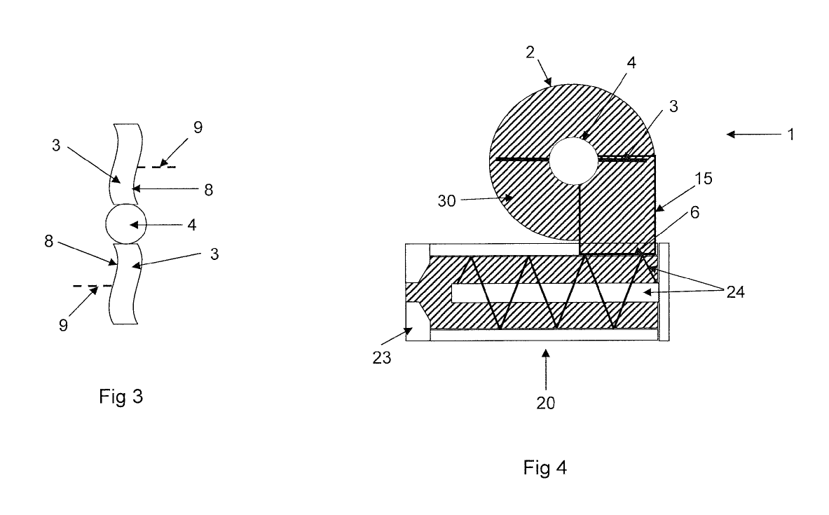

FIG. 3 a schematic representation of a mixer shaft with two discharge elements;

FIG. 4 a schematic representation of a device according to the invention with a downstream extruder;

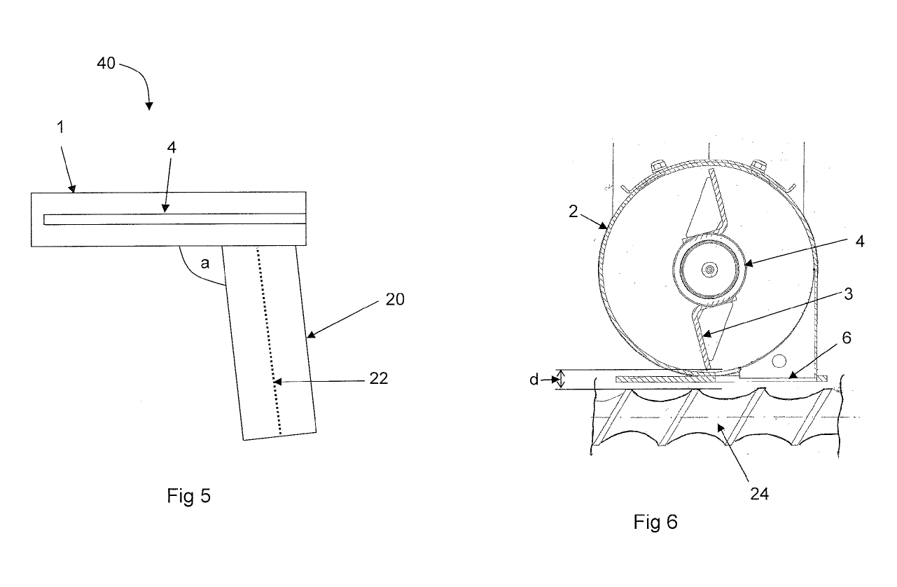

FIG. 5 a schematic representation of a plan view of a device according to the invention with a downstream extruder;

FIG. 6 a schematic representation of a device according to the invention with a downstream extruder shaft;

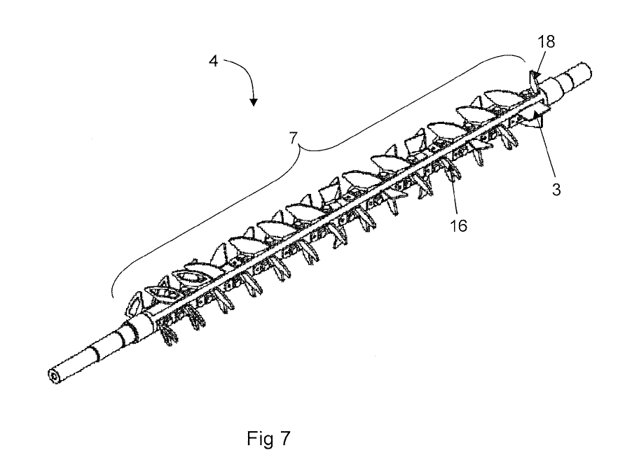

FIG. 7 a perspective representation of a mixer shaft according to the invention.

FIG. 1 shows a section through a mixing region of a device 1 according to the invention. The device 1 has in cross section a substantially circular housing 2 with a mixer shaft 4. Attached to this mixer shaft 4 are two discharge elements 3 with effective surfaces 8. The effective surfaces 8 have a perpendicular 9 to the surface. The housing 2 also has an outlet channel 15 with an outlet channel axis 10 and an outlet opening 6 with the outlet channel cross section 17. Here, the effective surface 8 of the discharge element 3 covers 50% of the smallest outlet channel cross section 17, i.e. here the outlet opening 6, when the effective surface 3 is projected parallel to the outlet channel axis 10 onto the outlet opening 6, when the perpendicular 9 to the surface and the outlet channel axis 10 lie parallel to each other.

FIG. 2 shows in a perspective representation a detail of the device 1 according to the invention. The housing 2 is formed substantially cylindrically in the mixing region 7 represented here. An outlet channel 15 with a substantially square cross section has an outlet opening 6. A mixer shaft 4 has in the region of the outlet opening 6 two discharge elements 3 with an effective surface 8.

FIG. 3 schematically shows a mixer shaft 4 with two discharge elements 3. These respectively have curved effective surfaces 8, with the perpendiculars 9 to the surface.

FIG. 4 schematically shows a device 1 with a downstream extruder 20. The device 1 has a substantially circular housing in cross section with a mixer shaft 4. This mixer shaft 4 has two discharge elements 3. Furthermore, the device 1 has an outlet channel 15 with an outlet opening 6. This outlet opening 6 is connected to the extruder such that the bulk material 30 can be transported from the device 1 into the extruder 20.

The bulk material 30 is therefore mixed in the device 1 in a first step and transported in the region of the device in which the outlet channel 15 is attached to the device 1. The bulk material is then transported substantially by the discharge elements 3 into the outlet channel 15. As a result, the bulk material 30 is transported through the outlet opening 6 into the extruder 20. In the extruder 20, the bulk material 30 is transported by means of the extruder shaft 24 along the longitudinal axis of the extruder shaft 24 to the die 23 and extruded there.

The longitudinal axis of the extruder and the axis of the mixer shaft 4 form an angle of substantially 90°.

FIG. 5 shows a plan view of an installation 40 with a device 1 according to the invention and a downstream extruder 20. The device 1 has a mixer shaft 4. The extruder 20 with the longitudinal axis 22 has an angle a of 95° between the axis of the mixer shaft 4 and the longitudinal axis 22 of the extruder 20.

An outlet opening of the device 1 and an inlet opening of the extruder 20 are not shown here.

FIG. 6 schematically shows a device 1 according to the invention with a downstream extruder shaft 24. The same references as are used in FIG. 1 designate the same components in FIG. 6.

A flank of the extruder shaft 24, i.e. the outer radius in the region of the device 1, is at a distance d perpendicularly to the extruder shaft 24 of no more than 10 mm from the radially outermost point of the discharge element 3 at least once per revolution.

FIG. 7 perspectively shows a mixer shaft 4 in the mixing region 7. The mixer shaft 4, which is part of the device not shown here with an outlet opening, has mixing elements 16 for mixing and transporting bulk material not shown here. Furthermore, the mixer shaft 4 has a discharge element 3 for improved transport of bulk material out of the device through the outlet opening. A return-transporting element 18 is suitable for transporting bulk material that has been transported past an outlet opening back into the region of the outlet opening.

1-15. (canceled)

16. A device for treating a bulk material, with a housing which is substantially cylindrical in a mixing region, comprising
at least one outlet channel with an outlet opening in the mixing region;
at least one rotatably mounted mixer shaft with at least one discharge element with an effective surface,
wherein, at intended use, the discharge element can be made to pass the outlet opening, wherein a projection of the effective surface parallel to the outlet channel axis onto the outlet opening covers the smallest outlet channel cross section by at least 45% at least once per revolution of the discharge element.

17. The device as claimed in claim 16, wherein the mixer shaft has two discharge elements.

18. The device as claimed in claim 16, wherein a perpendicular to the effective surface of at least one discharge element forms an angle of substantially 90° with the axis of the mixer shaft.

19. The device as claimed claim 16, wherein the mixer shaft has at least one mixing element and the perpendicular to the effective surface of at least one mixing element forms an angle of less than 90° with the axis of the mixer shaft.

20. The device as claimed in claim 16, wherein at least one discharge element has an effective surface which, parallel to the mixer shaft, is larger than the outlet opening.

21. The device as claimed in claim 16, wherein an extruder is arranged alongside the outlet opening and is connected to it such that a bulk material can be made to pass from the device to the extruder.

22. The device as claimed in claim 21, wherein the longitudinal axis of the extruder forms an angle of 60° to 120° with the axis of the mixer shaft.

23. The device as claimed in claim 21, wherein a flank of an extruder shaft has a minimum distance perpendicularly to the extruder shaft of no more than 20 mm from the radially outermost point of the discharge element at least once per revolution.

24. The device as claimed in claim 16, wherein the device is configured in such a way that the interior of the housing can be exposed to vapor.

25. The device as claimed in claim 16, wherein the device has a temperature control unit.

26. A method for treating, in particular mixing, a bulk material with a device, in particular as claimed in claim 16, characterized by the following steps:
a) introducing the bulk material into the device, which has the following features: a housing which is substantially cylindrical in a mixing region, comprising at least one outlet channel with an outlet opening in the mixing region, at least one rotatably mounted mixer shaft with at least one discharge element with an effective surface, wherein, at intended use, the discharge element can be made to pass the outlet opening, and wherein a projection of the effective surface parallel to the outlet channel axis onto the outlet opening covers the smallest outlet channel cross section by at least 45% at least once per revolution of the discharge element;
b) treating, in particular mixing, the bulk material in the device;
c) transporting the mixed bulk material to an outlet opening;
d) discharging the mixed bulk material from the device by means of the discharge element.

27. The method as claimed in claim 26, wherein, during the mixing in the device, the bulk material is exposed to vapor and/or is controlled in its temperature.

28. The method as claimed in claim 26, wherein the mixed bulk material discharged from the device is transported into an extruder.

29. A method for upgrading or converting an installation for processing raw materials, in particular bulk material, preferably an extrusion installation, wherein the installation is upgraded or converted with a device as claimed in claim 16.

30. A method for the use of the device as claimed in claim 16, as a conditioner for extrusion installations.
